(19) United States
(12) Patent Application Publication
(10) Pub. No.: US 2004/0028597 A1
(43) Pub. Date: Feb. 12, 2004

(54) Molecular arrangement with structural configuration and its use in quantum mechanical information processing

(76) Inventors: Markus Waiblinger, Berlin (DE); Wolfgang Harneit, Berlin (DE); Alois Weidinger, Berlin (DE)

Correspondence Address: Law Offices of Karl Hormann, PO Box 381516, Cambridge, MA, 02238-1516, US

(21) Appl. No.: 10/275,225

(22) PCT Filed: May 2, 2001
(86) PCT No.: PCT/DE01/01673

(30) Foreign Application Priority Data
May 2, 2000 (DE) 100-22-689.2

(51) Int. Cl. C01D 7/14

(52) U.S. Cl. 423/445 B

(57) ABSTRACT

While physically cage-type molecules differ significantly, they are of great chemical similarity so that thus far they cannot be arranged in controllable structures with respect to each other. By contrast, in accordance with the invention, molecular arrangements of geometrically uniform, even periodic, structural configurations of highly precise selectable spacings and angles can be realized in a self-organizing manner by chemically modifying the molecular cages by selective connection of addends. To this end, suitable pairs of types (P′) of addends (A′, B′) which are complementary and selective relative to each other are being used. These usually bilaterally bondable addends (A′, B′) are at one end bonded to defined selectable positions of the cage molecules (A, B) and form adducts (A₂, B₂) therewith. The other end is structured to be chemically highly selective so that the addends (A′, B′) only connect to each other by the chemical lock and key principle. Using stable endohedral fullerenes (Z@Cₓ with X≧60) as cage-type molecules which are filled with an electronspin-supporting atom (Z), it is possible to realize spatially highly precisely arranged electronspin systems for spin quantum computing which by the application of electron spin resonance have a very high detection sensitivity.

The invention relates to a molecular arrangement with a structural configuration of at least one adduct consisting of a cage-type molecule and at least one bilaterally bondable addend through which the adduct is bonded to at least one coupling partner, and to its use for quantum-mechanical data processing.

Cage-type molecules structured as fullerenes with different chemical and physical properties in varying applications are described in EP 0,615,055. The properties may be generated by the inclusion of atoms or molecules in the molecular cage. Also known from this publication are chemical modifications of the empty cages by polysubstitution by different functional groups which may also be used for forming polymers by linkage. It describes that the water solubility of fullerenes may be improved by branching (dendrone) by means of functional groups. Also, dendrimers based on fullerenes are known in which therapeutic or diagnostic groups are linked to the dendrimer. Cage-type molecules may also be used as basic components for dendrimers or as connection molecules. It is also known to provide endohedral fullerenes with an addend or to link these endohedral fullerenes to each other. Moreover, multi-adducts are being described as intermediate products for synthesizing fullerenes and for improving the properties of fullerenes. The synthesizing of defined fullerenes with regio-selective functional groups is also known as well. All substances known from EP 0,625,055 have in common that it is exclusively the chemical reactivity of fullerenes modified by addends for diagnostic and therapeutic purposes which is taken into consideration. When compounding the fullerenes always with dissimilar coupling partners, only the detection properties of the fullerenes in a wholly random geometric configuration are of any importance.

On the other hand, EP 0,591,595 discloses a molecular planar arrangement functioning as a data storage medium in which the coupling partner of cage-type molecules especially fullerenes, derivatives thereof or even zeolites of planar structural form is a substrate. For correctly reading data into and out of the storage medium the relative positioning of the cage-type molecules must take place vertically of the substrate surface in a flat mono-layer and the connection with the substrate must be very stable mechanically. Thus, for coupling addends are used which are functional groups and which directly or indirectly connect to the molecular cage on the one hand and to the substrate on the other hand either by forming or adding a further functional group. Hence, these addends are bonding agents serving to provide a mechanically stable contact between two components. During the alignment the cage-type molecules, in terms of top and bottom, remain coupled to each other so that it is not possible to attain precise positioning and spatial structural formation.

Addend substances with highly specific binding selectivity are know from biology and medicine. The best known example are the highly specialized complementary base pairs which lead to the characteristic structure of DNA in the double helix structure. Furthermore, it is possible to form specific antibodies against different configurations of molecules. In accordance with the chemical lock and key principle they bond themselves as highly selective complement fixation reaction to the molecule configurations and lead to their detection. For instance, a contrast medium for ultra sound is described in WO 9853857 which is compounded of three components. These are the contrast agent consisting of a cage-type molecule, a chemical spacer and a ligand or biomolecule. Among others, hormones, proteins, DNA, RNA and antibodies among others are being proposed as biomolecules. Even though the spacing aspect is here taken into consideration, no connection of the molecules between each other is aimed at. Rather, the sole aim is the chemical reactivity of the ligands with foreign molecules for the detection thereof. Another method of detection based on the lock and key principle is known from EP 0296481. This deals with a highly sensitive detection method specific to the type of gas which displays a lack of cross sensitivity relative to other types of gas contained in an air sample to be examined, based upon an enzymatic redox reaction in an aqueous solution. The lock and key principle is here applied to the gas to be detected and to a matching enzyme. In the field of the lock and key principle, a preparation of polymeric micro-particles with liposomes is known from DE44 28 056 which in the manner of linkers (bifunctional coupling agents with structure-specific properties) extract specific substances from blood. The locally-specific properties of the linkers mention in connection with the ligand-receptor bonding are not to be seen, however, in a dominant spatial connection but in a strictly chemical connection in a random phenomenon. Furthermore, from DE 44 02 756 it is known that immunologic bonding substances which contain a marker molecule, may bond to solid phases, such as, for instance balls of macroscopic dimensions. Here, too, the phenomenon is a random one.

In summary, therefore, the realizations of the lock and key principle known from chemistry and biology exclusively aim at a spatially random reaction with foreign partners for their detection. In this context, the emphasis is on chemical bonding processes with foreign partners. Bondings of adducts among each other for attaining geometric spatially aligned arrangements are not desired.

Proceeding from the molecular arrangement described in EP 0,591,595, it is thus an object of the invention further to develop the known molecular arrangement of the kind referred to supra, so as to obtain a geometric arrangement with a uniform structural form of adducts inter-connected in a controlled manner with placements of the cage-type molecules to be maintained with high precision. A high degree of reliability in the composition and reproducibility is to be ensured. Furthermore, the arrangement is to be synthesizable by simple fabrication methods and is to be useful in many different applications.

Proceeding from a molecular arrangement with a structural configuration of at least one adduct consisting of a cage-type molecule and at least one bilaterally bondable addends through which the adduct is bonded to at least one coupling partner, the object in accordance with the invention is, therefore, accomplished by the coupling partner, for producing a geometrically uniform structural configuration, being a further adduct consisting of a cage-type molecule and at least one bondable addend, the paired addends between two cage-type molecules being always structured complementary and selectively bondable in accordance with the chemical lock and key principle to connect the cage-type molecules to each other in a self-organized manner at highly precise formed angles and spacings. Advantageous embodiments of the invention may be gleaned from the sub-claims.

In the inventive molecular arrangement with geometrically uniform structural configuration the cage-type molecules are multifariously but unmistakably coded according to the lock and key principle through paired characteristic addends by chemical modification. In this manner, only those molecules can connect to each other which have been predetermined by the chemical addend modification. The highly precise positioning in the geometrically uniform structural configuration is attained by the unambiguous belonging together (cohesiveness) of the complementing pairs of selective addends which while able to form a bond with each other through one complementing bond, can never form such a bond with themselves. It is this highly specific selective bonding to each other of complementary addends by which an exactly positioned self-organization of the cage-type molecules is attainable in all spatial directions at a selectable geometry, composition and sequence. With suitably selected addends it is possible to attain cross-linking in complex arrangements with spatial expansion and even with a periodicity. Furthermore, it is possible by selection and number of addends to influence the structuring geometric relationships between the bonded cage-type molecules as regards their angles and spacings. The composition of the arrangement is determined by the selection of the cage-type molecules and their possible contents. The molecule cages precisely positioned within the arrangement may then be utilized for a stable and highly precise local fixing of possible cage contents. It is then possible to access the cage contents with great precision.

The spatial and material construction of the molecular arrangement of geometrically precise structural configuration may differ. In respect of the enzyme detection method referred to above it is known to mix the molecules to be coupled with each other in a solvent liquid, adding energy, in a single vessel (single vessel reaction). The molecular arrangement of geometrically uniform structural configuration may also be made in that manner. Simply by mixing, the desired adducts may initially be produced from the selected cage-type molecules and the matching addends, and the self-organizing compounds among the adducts may be made thereafter. By suitably selecting molecules and addends it is also possible to produce periodic systems. When preparing cage-type molecules, especially fullerenes, a certain number of addends may be coupled by well-known processes [see the article “Principles of fullerene reactivity”, A. Hirsch, in “Topics of Current Chemistry”, Vol. 199, Springer Verlag, Berlin, Germany (1999)] to precisely defined positions of the cage. In the case of the C₆₀-fullerene it is possible to bond between one and six addends, the bonding positions being located on the spatial axes. It is possible to bond two, possibly different, addends to diametrically opposed sites of the cage, or four addends in a square or six addends in a spatial arrangement. When bonding two addends the cage-type molecules will form a linear linkage, provided the preferred bonding sites are located on the axis of the cage. At a quadruple bond two addends each will be positioned on orthogonally disposed cage axes, thus forming a plane. The sextuple bonding of addends as pairs on all three axes of the cage is particularly interesting, leading to spatial structures of cage-type molecules. If required, the linear chains, planar surfaces or uniform bodies may then be affixed to surfaces relatively simply, be it by manipulation with scanning-probe techniques or by chemical activation of the surface. Similar structuring conditions result for silane cages (sphero-siloxanes), especially for the cubical silesquioxanes of the X₈Si₈O₁₂ formula where there are eight coupling sites X at the corners of the cube.

In connection with the single vessel process it is also possible by a selective preparation of cage-type molecules of different types with addend pairs of different kinds—these may, for instance, be configurations similar to the highly specific antigen-anti body compounds—to attain special or very selective molecular geometric arrangements of the different cage-type molecules among each other. To produce trimers as ternary groups of cage-type molecules the center molecule is modified with two selectively different addends and the two outer cage-type molecules are unilaterally modified with the corresponding complementary addend. Thereafter, the three modified types of molecules are mixed in a common solvent liquid where they arrange themselves in a dominant molecule by self-organization in a geometric uniform structural configuration well-defined by the code of the addends. The resultant trimer may have a linear structure by placing the addends of the center molecular cage on a molecule axis. This process may be extended to chains of any length the molecular sequence and geometric form of which may be controlled completely and with great precision.

Overall, the molecular arrangement of geometrically uniform structural configuration in accordance with the invention may be characterized by different combinations of different adducts. In particular this may be that cage-type molecules (a, B, C) of different types are coupled to each other in a repetitive sequence (more precise characterization of the geometrically uniform structural configuration in the dominant molecule by repetition, e.g.: ABCCA);

by a periodically repeating sequence of cage-type molecules (a, B, C) of different types (more precise characterization of the geometrically uniform structural configuration in the dominant molecule by periodic repetitions, e.g.: . . . a-a - - - a-a . . . , . . . ABCABC . . . ,);

the addends (a′, B″; B″, C′) belong to different types, which differ by the length of the addends and the coupling angle, (more precise characterization of the geometrically uniform structural configuration in the dominant molecule by spacings and angles, e.g. AP′AP″A,A-a - - - A,A\hat{ }a-a, a-B - - - a-B) and/or

the addends differ by the number of bondable sides (more precise characterization of the geometrically uniform structural configuration in the dominant molecule by chain or cross-linking formation).

On the basis of this characteristic elements of the structuring which may also be combined with each other, it is possible to show the multifarious structures and compositions of the molecular arrangement of geometrically uniform structural configuration in accordance with the invention. Depending on a given application the dominant molecule may thus be structurally configured in an optimum design by the structure fixing adducts. As regards the structures which may be obtained and in order to avoid repetition, reference may be had to the explanations in the particular section of the specification.

Cage-type molecules appear in different configurations and posses technically interesting properties. New kinds are being continually developed or discovered, such as, for instance, “silane cages” (sphero siloxane) and, more particularly silesquioxanes (Si₈O₁₂X₈) wherein X represents selectable and designable groups. Among the best known cage-type molecules at present are the fullerenes. In this connection, it is particularly interesting that the void of these cage-type molecules may be filled with atoms or molecules. These endohedral cages, depending on their contents, posses specific physical properties but are chemically similar to each other. Because of this chemical similarity it has heretofore been difficult or in many cases impossible to produce ordered or periodic sequences of endohedral molecules and, more particularly, of endohedral fullerenes. The present invention opens up the possibility of arranging endohedral cage-type molecules which are closely related chemically but dissimilar physically because of their fillings, by an allocation regimen determined by the selection of the kind of addends. The allocation regimen may, for instance, relate to the physical properties of the cages. Accordingly, this relates to an exohedral modification for the controlled arrangement of endohedral properties. Therefore, the molecular arrangement of geometrically uniform structuring may in addition to its geometric structuring also be characterized by its material structuring in particular by

the formation of at least one type of cage-type molecule as fullerene Cₓ;

the at least one fullerene being a stable endohedral fullerene Z@Cₓ;

the at least one stable endohedral fullerene Z@Cₓ having at least one metallic embedded element Z,

the at least one stable endohedral fullerene Z@Cₓ having at least one embedded element of atomic group V;

spin supporting atoms or molecule as embedded elements and/or

atoms or molecules as embedded elements of characteristic optical transitions.

Moreover, other material structures may also be realized, in particular by

the presence of at least one type of molecule as a silesquioxane on the basis of Si₈O₁₂,

the presence of the at least one silesquioxane as a stable endohedral silesquioxane Z@Si₈O₁₂ and/or

the presence of the at least one stable endohedral silesquioxane Z@Si₈O₁₂ having hydrogen H as its embedded element Z.

The molecular arrangement of geometrically uniform structural configuration in accordance with the invention may in many cases be applied wherever there is a need for a precise uniform, in particular, cross-linked structure in the molecular range. These may, for instance, be uni-, two- or three-dimensional grids for use as building blocks in modern optics (e.g. as storage or polarizing grids) where cage-type molecules of different optical properties are used, such as fullerenes with different enclosed atoms or clusters of atoms, for instance from the group of rare earths a use of the grids as molecular sieves is also conceivable, in which case the main function is carried out by appropriately selecting the length of the addends for defining the mesh size. Further functions of the grids and sieves by the selective enclosure, for instance of ferromagnetic types of atoms, are conceivable as well. At present, it is by no means possible to predict all possible applications of the structures of the molecular arrangements of geometrically uniform structural configuration which may be realized by the invention; they will profit by future developments in the field of cage-type molecules.

a particularly advantageous application of the molecular arrangement of geometrically uniform structural configuration in accordance with the invention resides in the possible physical realization of a quantum computer. Moreover, in accordance with a further development of the application specific properties of embedded elements present in the cage-type molecules may advantageously be utilized. In this connection, stable endohedral fullerenes with an embedded element of group V, more particularly nitrogen, may be used in particular a periodically linked structure as a geometrically well-defined spin system for spin quantum calculations is thus being proposed by the materially occupied molecular arrangement of geometrically uniform structural configuration in accordance with the invention. By an appropriate selection of filled molecular cages they may be used as the basis for the construction of a quantum computer. Suitable spin systems will then be realized by a selective combination of molecular cages (e.g. C₆₀) and one or more enclosed atoms. Atomic nitrogen N of an electron spin S=3/2 is particularly advantageous as it remains freely positioned in the center of the cage in contrast to metallic enclosures which accumulate at the interior wall of the cage. Furthermore, the used spin systems must have sufficiently long coherence times as well as defined quantum-mechanical coupling. In the molecular arrangement of geometrically uniform structural configuration in accordance with the invention, the first requirement is satisfied by the cage insulating the electron spin of the nitrogen atom from its environment. The fullerene cages serve to couple the electron spin supporting nitrogen atoms while maintaining the quantum-mechanical properties thereof. This is an important prerequisite for the construction of a quantum computer. In order to satisfy the second requirement, the spin must be a highly precise geometric arrangement of the spin or spin systems. This requirement, too, is optimally satisfied by the molecular arrangement of geometrically uniform structural configuration in accordance with the invention when using endohedral fullerenes by making available spin systems corresponding to the enclosed atoms.

a quantum computer is a system which makes possible controlled processing of quantum information. As a rule, a quantum computer is based on a quantum-mechanical two conditional system. In quantum computers quantum information is stored in internal degrees of freedom of a physical system. In contrast to a classical computer which is constructed of switching elements capable as switching positions of containing only the binary information 0 or 1, the information unit of quantum computers is a qubit. The difference between the classical switch and qubit is that in a qubit the information may also be present in the sense of a quantum-mechanical superposition of states. Instead of the switching position 0 and 1, any linear combinations of a times “state 0” and b times “state 1” are possible, whereby a and b may also be complex numbers. The possibility of simultaneously processing different register states by quantum-mechanical superposition makes it possible more effectively to solve certain mathematical problems in quantum computers than it is possible in a classical computer.

Hitherto, attempts at spin quantum computers have been based either on nuclear spin resonance with nuclear spins in special, even chain-like organized molecules (see U.S. Pat. No. 5,917,322) or on a nuclear spin resonance with nuclear spins in a solid body whereby the selection of the addressed spins and their coupling is to be controlled by special control inputs (see W09914858). However, the disadvantage of such spin quantum computers on the sole basis of nuclear spin resonance is their relatively low sensitivity. Also, it is difficult to realize a geometric arrangement in accordance with the concept disclosed by W09914858. In contrast, it is possible in the molecular arrangement of geometrically uniform structural configuration, by the selective chemical modification to link a large number of cage-type molecules with enclosed atoms in ordered, even periodic, systems. Since the enclosed atoms posses at least one detectable electron spin, the type of arrangement provided with uniform highly precise spacings and angles is particularly suitable for constructing a central processing unit (CPU) or a storage memory (RAM). In general, components for spin-based information processing may be realized by the present invention. The same applies to optical information to the extent the enclosed atoms posses special optical properties.

A CPU realized by the molecular arrangement of geometrically uniform structural configuration of the invention, in contrast to the known realization proposals exclusively based upon nuclear spin, is primarily based upon electron spin. In one possible realization the electron spins may take on the function of input and output gates for the information, whereas nuclear spins which are also present in the systems realized with the material of the invention, rather perform the task of information storage assigned by way of the gates. In another realization the information storage is performed in the electron spins as such. Further advantages of a spin-based electron system are the stronger polarizability of the electron spins and the significantly higher sensitivity of the electron spin resonance (ESR) connected therewith, relative to the nuclear spin resonance (NMR), resulting in an improved signal detectability, as well as the power over the necessary long relaxation and coherence times which depend on the selected type of molecule, for maintaining the state of all relevant spins. Moreover, a controlled constant coupling strength may be achieved between individual spins as a function of the constant predetermined spacing, by the predetermined geometric arrangement of the electron spins in the molecular arrangement of geometrically uniform structural configuration of the invention. This makes the system particularly suitable for the mentioned applications. In this connection, the interaction of the magnetic moments in the spin system required for quantum-mechanical information processing is ensured.

The statements made in connection with the generally cage-type molecules regarding their geometrically selective and controllable arrangement may also be applied to the arrangements of electron spins when using endohedral fullerenes with enclosures of nuclear character. By using suitable addends at the molecular cages of the fullerenes the spin-supporting molecules may be linked to periodic chains, two-dimensional nets or three-dimensional structures. In this manner, it is possible to obtain suitable geometric arrangements (spacings, angles) of the spins. By using different molecular cages or different fillings (e.g.: ¹⁴N@C₆₀, ¹⁵N@C₆₀, N@C₇₀, P@C₆₀) designer molecules may be selectively created. In this connection, the lock and key principle is of particular importance: cage type a (e.g. ¹⁵N@C₆₀) and cage type B (e.g. ¹⁴N@C₆₀) are each manipulated by the selective attachment of complementary addends. If cage type a and B thus prepared are mixed, the addends will connect in accordance with the lock and key principles to an alternating sequence . . . ABABAB . . . or to a surface or solid body. The alternating arrangement makes it possible to arrange a large number of spin systems at a defined spacing and, therefore, defined interaction. When using more the two types of cages and/or cage fillings it is possible to construct much more complex sequences on the basis of the lock and key method (e.g.: . . . ABCDABCD . . . ). In addition, with different addends the spacing and angles and, hence, the couplings between the spin systems may be set, e.g.: A-A - - - A-A . . . or A-B-A - - - B - - - A-B-A - - - B - - - . . .

Embodiments of the invention will hereafter be described in greater detail with reference to the schematic drawings in connection with the appropriate fabrication sequence. The figures depict different embodiments of the molecular arrangement of geometrically uniform structural configuration in accordance with the invention as well as a schematic drawing of the appurtenant preparatory operations. More particularly:

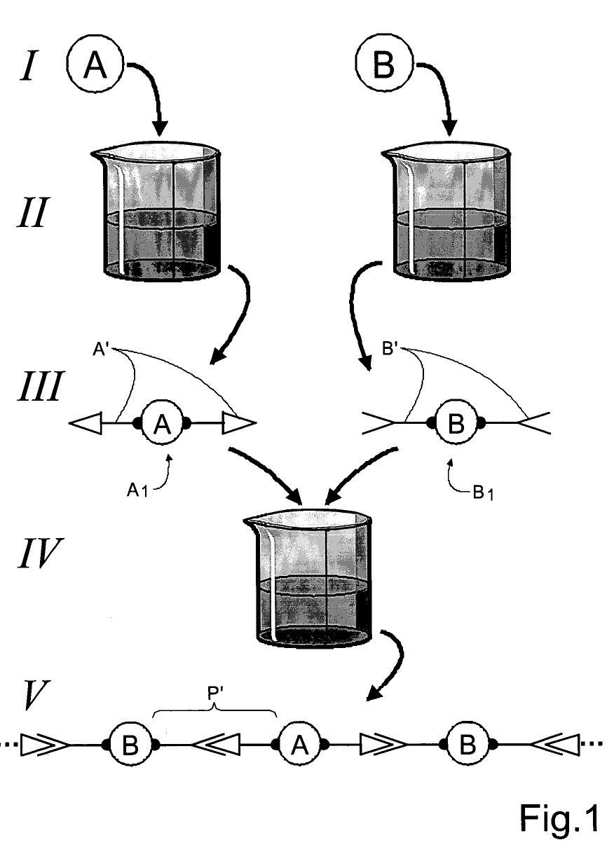

FIG. 1 depicts an embodiment with an alternating sequence structure;

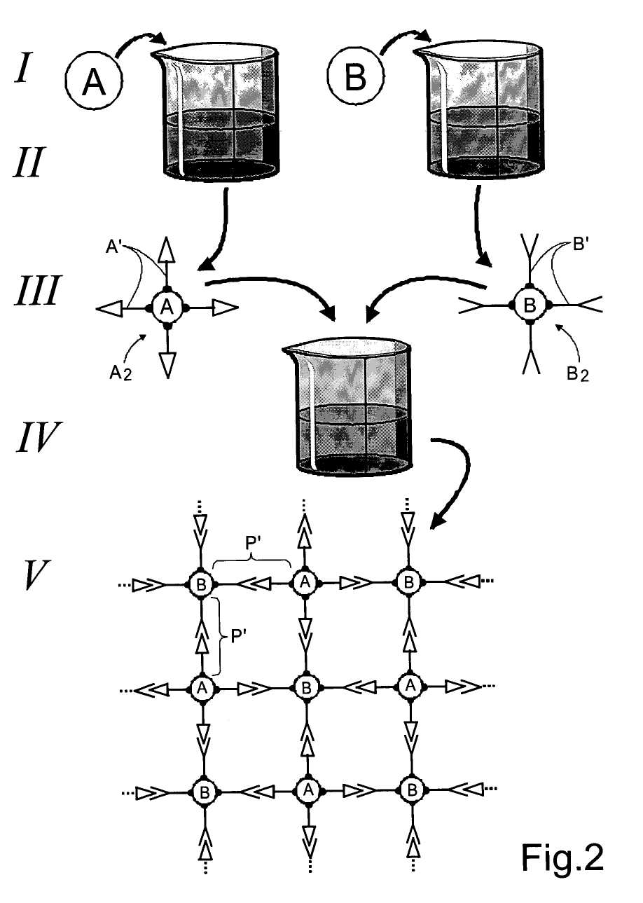

FIG. 2 depicts an embodiment with an alternating surface structure;

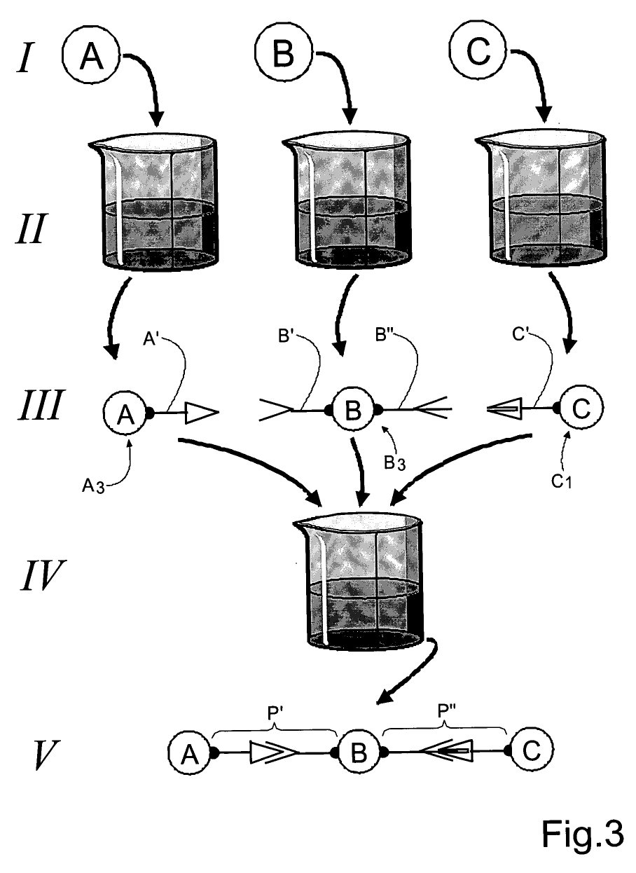

FIG. 3 depicts an embodiment with a tripel structure;

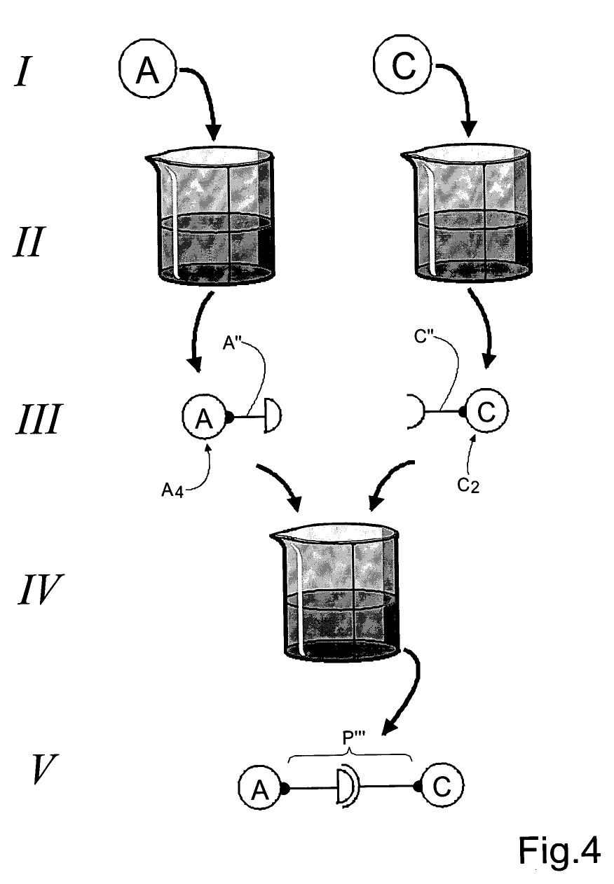

FIG. 4 depicts an embodiment with a dimer structure; and

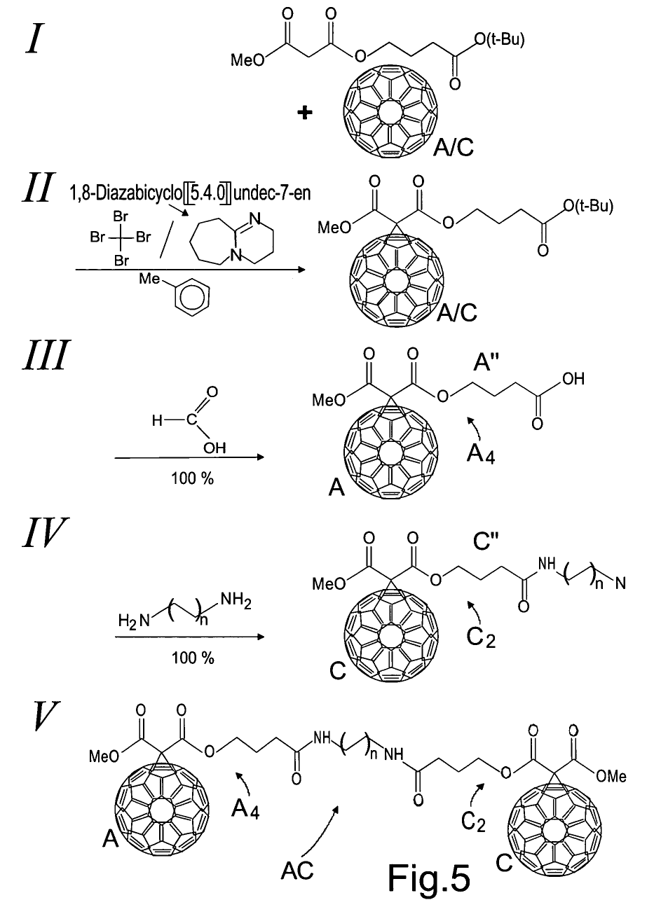

FIG. 5 depicts chemical structural formulae for the dimer of FIG. 4.

The embodiment 1 of FIG. 1 depicts an alternating sequence ( . . . ABABAB . . . ). The initial materials are two different types of endohedral fullerenes A (e.g.: N@C₆₀) and B (e.g.: P@C₆₀) (I). In separate process steps (II) suitable addends are attached to each type, e.g. two addends A′ are attached to type A, thus resulting in adduct A1, and two addends B′ are attached to type B (III), resulting in adduct B1. The different addends A′ and B′ form a pair of species P′ and are structured complementary and highly selectively relative to each other. They are thus formed such that they may form a bond with each other but not with themselves (lock and key principle). When the adducts A₁, B₁ thus prepared are mixed (IV), the cage-type molecules A, B will self-organizedly interlink through the addends A′,B′ to form alternating sequences . . . ABABAB. (V). In this process, the spacings between the cage-type molecules A, B, will be defined highly-precisely by the length of the addends A′, B′.

In FIG. 2, there is shown an embodiment 2 of alternating sequences in a surface or solid body. If the molecules are alternatingly to be connected to form a surface, the process of example 1 is initially followed, except that at the fullerenes A, B there will not be attached two, but four addends A′, B′ for producing adducts A₂, B₂. The addends A′, B′ will then be aligned 90° relative to each other. In a spatial alternating arrangement of molecules six addends will be attached to the molecules at the appropriate angular disposition. In these structures it is not only the spacings between individual molecules which are defined at high precision but also their angles relative to each other.

The embodiment shown in FIG. 3 is a linear trimer. In the selected embodiment three different endohedral fullerenes (e.g. A=¹⁴N@C₆₀, B=P@C₆₀ and C=¹⁵N@C₆₀) are required (I) for producing a trimer. It is also possible to use identical fullerenes. Addends A′ and C′ are respectively bonded to the fullerenes A and B resulting in adducts A₃ C. The fullerene B is provided with two addends B′ and B” yielding an adduct B₃ (II). The addends A′ and B′ as well as B″ and C′ form two different complementary selective pairs of addends P′, P″ and are again formed that only addends A′, B′ and B″, C′ may connect with each other (III). When the adducts A₃, B₃, C₁ are mixed (IV), the result will be self-organizedly structured ABC-trimers (V). The trimers may be subjected to a solvent. The trimers and, hence, the individual spins are maintained at highly precise spacings by the molecules of the solvent so that interaction of the spin systems can only occur within a trimer while it is strongly reduced relative to other trimers by the large spacing.

In FIG. 4, there is shown a simple dimer which is constituted by two adducts A₄, C₂ of molecule types A, C, each of which has only one bilaterally bondable addend A″, C″. These form a complementary selective pair of addends P′″ and bond exclusively with each other. The dimer thus formed is of a precisely defined length and it may, for instance, be affixed on a substrate by suitable processes.

With reference to the dimer of FIG. 4, FIG. 5 depicts an example from an almost infinite number of possible embodiments using endohedral fullerenes ZCₓ as cage-type molecules A, C and malonate as initial substance for the addends A″, C″. The preparation of the target compound of the dimer will be described hereafter.

I) Initially, malonate is being separately produced by a convergent synthesis well-known to persons skilled in the art and the addition of energy (Presentation I on the top of the drawing). The synthetic malonate is a metal salt of malonic acid (H₂[COOH]₂ with an inert tertiary butyl protective group (tBu). The malonate is provided with an especially reactive carbon bonding position.

II) Thereafter, by cyclo-propanation (1,8-diazabicyclo[5.4.0]undec-7-en), the malonate is linked by its free bonding position to a preferred position of the cage of a fullerene A. The yield per step of the synthesis amounts to about 10%. The non-converted molecules are separated and may be used again in a further synthesis. In this manner only one type of molecular cage is converted (type A, e.g.: N@C₆₀).

III) In a further step the tertiary butyl protection group (t-Bu) is split off the malonate by a formic acid (HCOOH) treatment leaving at the malonate a free terminal carboxyl group (COH) as addend A″ and forming the adduct A₄. The yield of this step of the synthesis amounts to almost 100%. The purpose of the tertiary butyl protection group (t-Bu) is by alignment to link the proper side of the addend A″ with the fullerene A. By removing the tertiary butyl protection group (t-Bu) the malonate linked to the fullerene is being “primed” and may react with a corresponding partner. Thus, it takes on the role of a “chemical lock”.

IV) The synthesis steps I-III are repeated with another cage-type molecule C (type C, e.g.: P@C₆₀). Thereafter, the malonate is prepared by a further synthesis step such that the chemical lock is converted to a chemical key. By simple mixing of type C with an amide group chain H₂N(CH₂)ₙNH₂, the group reacts with the OH ending of the addend A″ attached to the fullerene by releasing an amino acid to addend C″, thus forming adduct C2. This synthesis step, too, leads to an almost 100% conversion of the molecules. By a suitable selection of the number n of CH₂-groups the length of the addend C″ may be defined which defines the spacing between the fullerenes A, C during subsequent linking.

V) The adducts A₄, C₂ will now be mixed. This leads to conversion of addend C″ as an amide which still has a free amino acid, with the free oxygen bond at addend A″ in adduct A₄, by renewed amide coupling and release of oxygen, to the desired dimer AC. The yield of the conversion amounts to almost 80%. The spacing between the two fullerenes A, C is thus set in a highly precise manner.

What is claimed is:

1. A molecular arrangement with a structural configuration of at least one adduct consisting of one cage-type molecule and at least one bilaterally bondable addend by which the adduct is coupled to at least one coupling partner
characterized by the fact that
for forming a geometrically uniform structural configuration the coupling partner comprises a further adduct (A_{1 . . . 4}, B_{1 . . . 3, C}_{1 . . . 2}) made up of a cage-type molecule (A, B, C) and at least one bondable addend (A′, A″, B′, B″, C′, C″) whereby in accordance with the chemical lock and key principle the paired addends (P′, P″, P′″) between two cage-type molecules (A,B; B,C; A,C) are formed complementary and bond-selective relative to each other to couple the cage-type molecules (A, B, C) in a self-organizing manner by highly precisely formed angles and spacings.

2. The molecular arrangement of claim 1,
characterized by the fact that
that cage-type molecules (A, B, C) of different types are coupled to each other in a repetitive, especially periodic sequence.

3. The molecular arrangement of claim 2,
characterized by the fact that
the addends (A′, A″, B′, B″, C′, C″) belong to different types which differ by the length of the addend, the coupling angle and the number of bondable sides.

4. The molecular arrangement of claim 3,
characterized by the fact that
the paired (P′″ addends (A″, C″) are based upon a complementarily and selectively formed malonate which by splitting off of an inert protection group (t-Bu) functions as a lock and which by adding an amide group chain (nNH) of determinable length functions as a key.

5. The molecular arrangement of claim 1,
characterized by the fact that
at least one type of cage-type molecule (A, B, C) is structured as a fullerene.

6. The molecular arrangement of claim 1,
characterized by the fact that
at least one type of cage-type molecule is structured as a silesquioxane based on Si₈O₁₂.

7. The molecular arrangement of claim 1,
characterized by the fact that
the cage-type molecule type (Z@Cₓ) is structured as a stable endohedron with an embedded element (Z).

8. The molecular arrangement of claim 7,
characterized by the fact that
the embedded element (Z) is a metallic embedded element.

9. The molecular arrangement of claim 7,
characterized by the fact that
the embedded element (Z) is an embedded element from atomic group V.

10. The molecular arrangement of claims 7,
characterized by the fact that
that the embedded element (Z) is a spin-supporting atom (N, H) or molecule.

11. The molecular arrangement of claim 7,
characterized by the fact that
the embedded element (Z) is provided with a characteristic optical transition.

12. The molecular arrangement of claim 1,
characterized by the fact
it comprises a central processing unit (CPU) of quantum computer.

13. The molecular arrangement of claim 12,
characterized by
a utilization of specific properties of present embedded elements (Z) in the cage-type molecules (A, B, C).
